(19) United States
(12) Patent Application Publication
(10) Pub. No.: US 2007/0123654 A1
(43) Pub. Date: May 31, 2007

(54) Novel uses of unmodified polyolefins and of graft polyolefins

(75) Inventors: Henri Wautier, Braine Le Comte (BE); Marie-Paule Collard, Vilvoorde (BE); Dino Manfredi, Lummen (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), BRUSSELS (BE)

(21) Appl. No.: 10/573,807

(22) PCT Filed: Sep. 29, 2004
(86) PCT No.: PCT/EP04/52363

§ 371 Date: Mar. 28, 2006

(30) Foreign Application Priority Data
Sep. 29, 2003 (FR) 03.11395
Sep. 29, 2003 (FR) 03.11394
Feb. 27, 2004 (EP) PCT/EP04/02082
Aug. 13, 2004 (BE) 2004/0398

(51) Int. Cl. C08F 8/00

(52) U.S. Cl. 525/191

(57) ABSTRACT

Use of at least one unmodified polyolefin [polyolefin (P1)] as additive for a polyolefin composition (C2) comprising at least one polyolefin modified by grafting with acid and/or anhydride groups, which groups are optionally completely or partially neutralized by a neutralizing agent [polyolefin (P2)], for improving the level of at least one mechanical property of the polyolefin composition (C2) up to a level which is improved both with respect to that of the mechanical property of the polyolefin composition (C2) and with respect to that of the mechanical property of a polyolefin composition (C1) obtained by replacing, weight for weight in the polyolefin composition (C2), all the modified polyolefin (P2) by the unmodified polyolefin (P1). Use of at least one polyolefin modified by grafting with acid and/or anhydride groups, which groups are optionally completely or partially neutralized by at least one neutralizing agent [polyolefin (P2)], as additive for a polyolefin composition (C1) comprising at least one unmodified polyolefin [polyolefin (P1)] for improving the level of at least one mechanical property of the polyolefin composition (C1) up to a level which is improved both with respect to that of the mechanical property of the polyolefin composition (C1) and with respect to that of the mechanical property of a polyolefin composition (C2) obtained by replacing, weight for weight in the polyolefin composition (C1), all the unmodified polyolefin (P1) by the modified polyolefin (P2).

The present invention relates to novel uses of unmodified polypropylenes and of grafted polypropylenes and more generally of unmodified polyolefins and of grafted polyolefins.

Since they have existed, unmodified polypropylenes and more generally unmodified polyolefins having been valued for their advantageous properties in conjunction with their low cost. Thus, at the present time, they are used, preferably with any other plastic, in particular for applications with regard to pipes, films, sheets, hollow bodies and various components of motor vehicles, such as fuel tanks.

However, it often happened that the level of the mechanical properties achieved by unmodified polypropylenes and more generally by unmodified polyolefins did not reach the level required for the applications envisaged. The mechanical properties concerned relate in particular to the low-speed mechanical behaviour (tensile elastic modulus, elongation at break, and the like), the high-speed mechanical behaviour (impact strength and/or peak force in the instrumented falling weight test and the like), the operating temperature range (softening temperature in the Vicat test, and the like) and the change in the mechanical behaviour of the material over time (creep test, and the like). Properties such as the adhesion to a support (which depends critically on the chemical nature of the support) or the dispersibility in a dispersing liquid are not mechanical properties within the meaning of the present invention.

It has already been reported that a substantial improvement in the level of certain mechanical properties of unmodified polypropylenes (and more generally of unmodified polyolefins) can sometimes be obtained by grafting acid and/or anhydride groups to polypropylenes (and more generally to polyolefins).

If appropriate, and due to the greater cost of grafted polypropylenes (and more generally of granted polyolefins) in comparison with their unmodified homologues, a person skilled in the art who was satisfied with an intermediate level of mechanical properties has already manufactured blends of unmodified polypropylene and of grafted polypropylene in order to achieve the desired level. Thus, Patent Application GB 1 335 791 on behalf of Eastman Kodak discloses blends of unmodified polypropylene and of polypropylene grafted with maleic anhydride which exhibit a level of tensile strength intermediate between that of the unmodified polypropylene and that of the grafted polypropylene (cf. Table 3 and 6) or, at best, equivalent to that of the unmodified polypropylene (as illustrated in Table 1).

In other cases, the requirements for mechanical properties cannot be met, either because the grafted polypropylenes (and more generally the grafted polyolefins) behave less well, for the mechanical properties concerned, than their unmodified homologues or because they admittedly behaved better but without reaching the particularly high level which was required, namely a level improved both with respect to that of the unmodified polypropylenes (and more generally to that of the unmodified polyolefins) and with respect to that of the grafted polypropylenes (and more generally to that of the grafted polyolefins). The problem with which a person skilled in the art was thus confronted was that of finding by what means as high a level of mechanical property could be achieved.

In an entirely surprising way, and overcoming the preconception according to which a blend of an unmodified polypropylene and of a grafted polypropylene (or more generally of an unmodified polyolefin and of a grafted polyolefin) irredeemably only made it possible to achieve an intermediate property level or, at the very best, a property level equivalent to that of each of the components taken individually, the Applicant Company has found that, by a judicious choice of the unmodified polypropylene and of the grafted polypropylene suited to the mechanical property or properties to be improved, a synergistic effect could be obtained, it being possible for the polyolefin combination to achieve a mechanical property level which is improved both with respect to that of the unmodified polypropylene (or more generally of the unmodified polyolefin) and with respect to that of the grafted polypropylene (or more generally with respect to that of the grafted polyolefin).

A first aspect of the present invention consequently relates to the use of at least one unmodified polyolefin [polyolefin (P 1)] as additive for a polyolefin composition (C2) comprising at least one polyolefin modified by grafting with acid and/or anhydride groups, which groups are optionally completely or partially neutralized by a neutralizing agent [polyolefin (P2)], for improving the level of at least one mechanical property of the polyolefin composition (C2) up to a level which is improved both with respect to that of the mechanical property of the polyolefin composition (C2) and with respect to that of the mechanical property of a polyolefin composition (C1) obtained by replacing, weight for weight in the polyolefin composition (C2), all the modified polyolefin (P2) by the unmodified polyolefin (P1).

The ratio by weight q_{w2} of the polyolefin (P2) to the polyolefin composition (C2) [(P2):(C2)], before the addition of the polyolefin (P1) is advantageously greater than 0.50, preferably greater than 0.90, particularly preferably greater than 0.99 and very particularly preferably greater than 0.995; they can then either be composed of a polyolefin (P2) or be composed of the polyolefin (P2) and of less than 0.5% of ingredients conventional for polyolefin compositions, such as heat stabilizers and antioxidants.

A second aspect of the present invention relates to the use of at least one polyolefin modified by grafting with acid and/or anhydride groups, which groups are optionally completely or partially neutralized by at least one neutralizing agent [polyolefin (P2)], as additive for a polyolefin composition (C1) comprising at least one unmodified polyolefin [polyolefin (P1)] for improving the level of at least one mechanical property of the polyolefin composition (C1) up to a level which is improved both with respect to that of the mechanical property of the polyolefin composition (C1) and with respect to that of the mechanical property of a polyolefin composition (C2) obtained by replacing, weight for weight in the polyolefin composition (C1), all the unmodified polyolefin (P1) by the modified polyolefin (P2).

The ratio by weight q_{w1} of the polyolefin (P1) to the polyolefin composition (C1) [(P1):(C1)], before the addition of the polyolefin (P2) is advantageously greater than 0.50, preferably greater than 0.90, particularly preferably greater than 0.99 and very particularly preferably greater than 0.995; they can then either be composed of a polyolefin (P1) or be composed of the polyolefin (P1) and of less than 0.5% of ingredients conventional for polyolefin compositions, such as heat stabilizers and antioxidants.

Unless otherwise specified, the definitions and preferences relating to the polyolefins described in detail below relate both to the unmodified polyolefin [polyolefin (P1)] and to the modified polyolefin [polyolefin (P2)] considered according to the different aspects of the invention.

The term “polyolefin” is understood to denote a polymer, more than 50% by weight of the repeat units of which are derived from at least one alkene.

Mention may be made, as examples of alkenes, of linear olefins comprising from 2 to 12 carbon atoms, such as ethylene, propylene, 1-butene, 1-pentene, 1-hexene, 1-heptene, le 1-octene, 1-nonene, 1-decene, 1-undecene and 1-dodecene.

The polyolefins under consideration in the different aspects of the invention can be selected in particular from homopolymers of the abovementioned olefins and from copolymers of these olefins, in particular copolymers of propylene with one or more comonomers, and from blends of such polymers. The comonomers can be chosen in particular from the linear olefins described above, from styrene monomers, such as styrene and α-methylstyrene, and from alkadienes; however, the polyolefins under consideration in the different aspects of the invention are preferably devoid of repeat units derived from an alkadiene. The content by weight of units formed from the comonomers in the polyolefins is advantageously less than 30% and preferably less than 10% by weight. It is understood that the term “polyolefin” is intended equally well to denote the polymers described above taken in isolation as their blends.

The acid and/or anhydride groups which are grafted to the polyolefin (P2) are advantageously derived from at least one grafting monomer chosen from unsaturated mono- or dicarboxylic acids and their derivatives and unsaturated anhydrides of mono- or dicarboxylic acids and their derivatives. These grafting monomers preferably comprise from 3 to 20 carbon atoms. Mention may be made, as typical examples, of acrylic acid, methacrylic acid, maleic acid, fumaric acid, itaconic acid, crotonic acid, citraconic acid, maleic anhydride, itaconic anhydride, crotonic anhydride and citraconic anhydride. Maleic anhydride is very particularly preferred.

The amount of acid and/or anhydride groups grafted is advantageously greater than 0.01% by weight, with respect to the weight of the polyolefin (P2), preferably than 0.02% by weight or better still than 0.03% by weight. In addition, this amount is advantageously less than or equal to 2.0% by weight, preferably less than or equal to 1.5% by weight and better still less than or equal to 1.0% by weight.

The grafting of the acid and/or anhydride groups is advantageously initiated by a radical-generating agent. Mention may in particular be made, as radical-generating agent, of t-butyl cumyl peroxide, 1,3-di(2-(t-butylperoxy)isopropyl)benzene, 2,5-dimethyl-2,5-di(t-butylperoxy)hexane, di(t-butyl) peroxide and 2,5-dimethyl-2,5-di(t-butylperoxy)-3-hexyne. 2,5-Dimethyl-2,5-di(t-butylperoxyhexane) (DHBP) has made it possible to synthesize grafted polyolefins which have given good results relating to the different aspects of the present invention.

The polyolefin (P2) advantageously comprises little in the way of free (ungrafted) grafting monomer, typically an amount of less than or equal to 500 ppm, preferably of less than 400 ppm and particularly preferably of less than 200 ppm. To this end, the polyolefin (P2) has advantageously been purified of free grafting monomer, preferably by entrainment with acetone, by stripping with hot air, by stripping with steam, by stripping with an inert gas or by degassing.

When the acid and/or anhydride groups of the polyolefin (P2) are completely or partially neutralized, a neutralizing agent is normally used for this purpose.

The neutralizing agent can be an inorganic salt, an organic salt or also a mixture of an organic salt and of an inorganic salt.

The inorganic salt, whether used alone or as a mixture, is preferably a hydroxide, a carbonate, a bicarbonate, a phosphate or a monohydrogenphosphate of an alkali metal. Sodium carbonate is particularly preferred.

The organic salt, whether used alone or as a mixture, is preferably a carboxylate or a mono- or polyhydroxycarboxylate of a metal which can in particular be an alkali metal, an alkaline earth metal, a metal from Group IIIa of the Periodic Table of the Elements or a transition metal. Particularly preferably, the organic salt is a carboxylate of a transition metal or a mono- or polyhydroxycarboxylate-alkali metal. Very particularly preferably, the organic salt is chosen from sodium lactate and zinc acetate.

The neutralizing agent is preferably an organic salt or a mixture of an organic salt and of an inorganic salt. Particularly preferably, the neutralizing agent is a mixture of an organic salt and of an inorganic salt. Excellent results have been obtained using, as neutralizing agent, either a mixture of sodium lactate and of sodium carbonate or a mixture of zinc acetate and of sodium carbonate.

The neutralizing agent is used in an amount preferably of greater than 0.5 molar equivalent with respect to the number of the acid and/or anhydride groups of a polyolefin (P2). Furthermore, the neutralizing agent is used in an amount preferably of less than 3 mol. eq. with respect to the number of the acid and/or anhydride groups of the polyolefin (P2).

The polyolefin (P1) can in particular be a polyethylene.

Unless otherwise specified, the definitions and preferences relating to the polyethylenes described in detail below relate both to the unmodified polyolefin [polyolefin (P1)] and to the modified polyolefin [polyolefin (P2)] under consideration in the different aspects of the invention each time that (P1) and/or (P2) is a polyethylene.

The term “polyethylene” is understood to denote a polymer, more than 50% by weight of the repeat units of which are derived from ethylene.

The polyethylenes under consideration in the different aspects of the invention can be selected in particular from ethylene homopolymers and from copolymers of ethylene with one or more comonomers, and also from blends of such polymers. The comonomers can be chosen in particular from the linear olefins described above, in particular propylene, from styrene monomers, such as styrene and α-methylstyrene, and from alkadienes; the polyethylenes are preferably devoid of repeat units derived from an alkadiene. The content by weight of units formed from the comonomers in the polyethylenes is advantageously less than 30% by weight and preferably less than 10% by weight. It is understood that the term “polyethylene” is intended equally well to denote the polyethylenes as described above taken in isolation as their blends.

The polyolefin (P1) is preferably a poly-α-olefin.

Unless otherwise specified, the definitions and preferences relating to the poly-α-olefins described in detail below relate both to the unmodified polyolefin [polyolefin (P1)] and to the modified polyolefin [polyolefin (P2)] under consideration in the different aspects of the invention each time that (P1) and/or (P2) is a poly-α-olefin.

The term “poly-α-olefin” is understood to denote a polymer, more than 50% by weight of the repeat units of which are derived from an α-olefin.

The term “α-olefin” is understood to denote an alkene comprising at least 3 carbon atoms. The α-olefin preferably comprises at most 12 carbon atoms. In addition, it is preferably linear.

The poly-α-olefins under consideration in the different aspects of the invention can be selected from homopolymers of an α-olefin and from copolymers of an α-olefin with one or more comonomers, and from blends of such polymers. The comonomers can be chosen in particular from the linear olefins described above, in particular ethylene, from styrene monomers, such as styrene and α-methylstyrene, and from alkadiene; the poly-α-olefins are preferably devoid of repeat units derived from an alkadiene. The content by weight of units formed from the comonomers in poly-α-olefins is advantageously less than 30% by weight and preferably less than 10% by weight. It is understood that the term “poly-α-olefin” is intended equally well to denote the poly-α-olefins as described above taken in isolation as their blends.

In a particularly preferred way, the polyolefin (P1) is a polypropylene.

Unless otherwise specified, the definitions and preferences relating to the polypropylenes described in detail below relate both to the unmodified polyolefin [polyolefin (P1)] and to the modified polyolefin [polyolefin (P2)] under consideration in the different aspects of the invention each time that (P1) and/or (P2) is a polypropylene.

The term “polypropylene” is understood to denote a polymer, more than 50% by weight of the repeat units of which are derived from propylene.

The polypropylenes under consideration in the different aspects of the invention can be selected from propylene homopolymers and from copolymers of propylene with one or more comonomers, and from blends of such polymers. The comonomers can be chosen in particular from the linear olefins described above, in particular ethylene, from styrene monomers, such as styrene and α-methylstyrene, and from alkadiene; the polypropylenes are preferably devoid of repeat units derived from an alkadiene. The content by weight of units formed from the comonomers in the polyethylenes is advantageously less than 30% by weight and preferably less than 10% by weight. It is understood that the term “polypropylene” is intended equally well to denote the polypropylenes as described above taken in isolation as their blends.

The polyolefin (P2) can in particular be a polyethylene.

The polyolefin (P2) is preferably a poly-α-olefin.

The polyolefin (P2) is particularly preferably a polypropylene.

According to a first specific aspect of the invention [aspect (A1)], the mechanical property relates at least to the low-speed mechanical behaviour.

According to a first preferred subaspect of (A1), the mechanical property comprises the tensile elastic modulus. To improve the level of the tensile elastic modulus means to increase it.

According to a second preferred subaspect of (A1), the mechanical property comprises the elongation at break. To improve the level of the elongation at break means to increase it.

According to a second specific aspect of the invention [aspect (A2)], the mechanical property relates at least to the operating temperature range.

According to the aspect (A2), the mechanical property preferably comprises the softening temperature in the Vicat 10N test. To improve the level of the softening temperature in the Vicat 10N test means to increase it.

According to a third specific aspect of the invention [aspect (A3)], the mechanical property relates at least to the high-speed mechanical behaviour.

According to the aspect (A3), the mechanical property preferably comprises the impact strength and/or the peak force in the instrumented falling weight test; particularly preferably, it comprises both. To improve the level of the impact strength means to increase it; to improve the level of the peak force also means to increase it.

According to a fourth specific aspect of the invention [aspect (A4)], the mechanical property relates at least to the change in the mechanical behaviour of the material over time.

According to the specific aspect of the invention (A4), the mechanical property preferably comprises the tensile elastic modulus after 100 h under a stress of 10 MPa. To improve the level of the tensile elastic modulus after 100 h under a stress of 10 MPa means to increase it.

A first particularly advantageous embodiment of the invention [embodiment (I)] involves a propylene homopolymer as polyolefin (P1).

The term “propylene homopolymer” is intended to denote a polymer, all the repeat units of which are derived from propylene.

According to the embodiment (I), the polyolefin (P2) is preferably a propylene homopolymer.

The acid and/or anhydride groups of the polyolefin (P2) which is a propylene homopolymer may not be neutralized [embodiment (I.1)].

According to the embodiment (I.1), it is preferable for the mechanical property to relate at least to the low-speed mechanical behaviour. Particularly preferably, the mechanical property comprises the elongation at break.

According to the embodiment (I.1), it is also preferable for the mechanical property to relate at least to the operating temperature range. Particularly preferably, the mechanical property comprises the softening temperature in the Vicat 10N test.

According to the embodiment (I.1), it is finally preferable for the mechanical property to relate at least to the change in the mechanical behaviour over time. Particularly preferably, the mechanical property comprises the tensile elastic modulus after 100 h under a stress of 10 MPa.

Alternatively, the acid and/or anhydride groups of the polyolefin (P2) which is a propylene homopolymer may be completely or partially neutralized [embodiment (I.2)].

According to the embodiment (I.2), it is preferable for the mechanical property to relate at least to the low-speed mechanical behaviour. Particularly preferably, the mechanical property comprises the elongation at break.

According to the embodiment (1.2), it is also preferably for the mechanical property to relate at least to the operating temperature range. Particularly preferably, the mechanical property comprises the softening temperature in the Vicat 10N test.

According to the embodiment (1.2), it is finally preferable for the mechanical property to relate at least to the high-speed mechanical behaviour. Particularly preferably, the mechanical property comprises the impact strength and/or the peak force in the instrumented falling weight test. Very particularly preferably, it comprises both.

A second particularly advantageous embodiment of the invention [embodiment (II)] involves a random propylene copolymer as polyolefin (P1).

The term “random propylene copolymer” is intended to denote a copolymer, more than 90% by weight of the repeat units of which are derived from propylene. The repeat units not derived from propylene advantageously are repeat units derived from ethylene.

According to the embodiment (II), the polyolefin (P2) is preferably a random propylene copolymer.

The acid and/or anhydride groups of the polyolefin (P2) which is a random propylene copolymer may not be neutralized [embodiment (II.1)].

According to the embodiment (II.1), it is preferable for the mechanical property to relate at least to the low-speed mechanical behaviour. Particularly preferably, the mechanical property comprises the tensile elastic modulus.

Alternatively, the acid and/or anhydride groups of the polyolefin (P2) which is a random propylene copolymer may be completely or partially neutralized [embodiment (II.2)].

According to the embodiment (II.2), it is preferable for the mechanical property to relate at least to the high-speed mechanical behaviour. Particularly preferably, the mechanical property comprises the impact strength and/or the peak force in the instrumented falling weight test. Very particularly preferably, the mechanical property comprises both.

The ratio by weight r_{w} of the polyolefin (P1) to the polyolefin (P2) [(P1):(P2)] can be easily adjusted by persons skilled in the art in the light of the use under consideration, this being the case for all of the aspects of the invention.

The ratio by weight r_{w} of the polyolefin (P1) to the polyolefin (P2) [(P1):(P2)] is preferably greater than 1, particularly preferably greater than 4, very particularly preferably greater than 8. In the latter case, it has been confirmed that, depending upon the use under consideration, it was sometimes preferable for r_{w} to be less than 16 and sometimes for it to be greater than or equal to 16.

In addition, the ratio by weight r_{w} of the polyolefin (P1) to the polyolefin (P2) [(P1):(P2)] is preferably less than 100, particularly preferably less than 50, very particularly preferably less than 35 and most preferably less than 25.

A third aspect of the present invention relates to a process for the preparation of a polyolefin composition which is improved with respect to a preexisting polyolefin composition (C2) comprising at least one polyolefin modified by grafting with acid and/or anhydride groups which are optionally completely or partially neutralized by at least one neutralizing agent [polyolefin (P2)], the said process being carried out for the purpose of improving the level of at least one mechanical property of the preexisting polyolefin composition (C2) up to a level which is improved both with respect to that of the mechanical property of the preexisting polyolefin composition (C2) and with respect to that of the mechanical property of a polyolefin composition (C1) obtained by replacing, weight for weight in the preexisting polyolefin composition (C2), all of the modified polyolefin (P2) by at least one unmodified polyolefin [polyolefin (P1)] and the said process comprising the addition of the unmodified polyolefin (P1) to the preexisting polyolefin composition (C2) during the actual preparation of the said composition or after having prepared the latter.

A fourth aspect of the present invention relates to a process for the preparation of a polyolefin composition which is improved with respect to a preexisting polyolefin composition (C1) comprising at least one unmodified polyolefin [polyolefin (P1)], the said process being carried out for the purpose of improving the level of at least one mechanical property of the preexisting polyolefin composition (C1) up to a level which is improved both with respect to that of the mechanical property of the preexisting polyolefin composition (C 1) and with respect to that of the mechanical property of a polyolefin composition (C2) obtained by replacing, weight for weight in the preexisting polyolefin composition (C1), all of the unmodified polyolefin (P1) by at least one polyolefin modified by grafting with acid and/or anhydride groups which are optionally completely or partially neutralized by at least one neutralizing agent [polyolefin (P2)] and the said process comprising the addition of the modified polyolefin (P2) to the preexisting polyolefin composition (C1) during the actual preparation of the said composition or after having prepared the latter.

All the definitions and preferences given in detail for the first two aspects of the present invention are also valid in the same way for the third and fourth aspects of the invention.

Thus, in particular, the polyolefin (P1) is preferably a poly-α-olefin, particularly preferably a polypropylene, in particular a propylene homopolymer or a random propylene copolymer. Likewise, the polyolefin (P2) is preferably a poly-α-olefin, particularly preferably a polypropylene, in particular a propylene homopolymer or a random polypropylene copolymer.

A final aspect of the present invention relates to a semifinished or finished article comprising at least one improved polyolefin composition prepared by the process described in detail above.

A first preferred choice for the article according to the invention is that made from pipes, films, sheets, fibres, foams and blown hollow bodies made of the composition or of the modified polyolefin.

Mention may be made, as examples of blown hollow bodies, of bottles.

The pipes are advantageously intended for the oil industry, for the building industry or for the motor vehicle industry.

The films can in particular be food films sealable in a greasy medium or films which can be printed with aqueous inks.

A second preferred choice for the article according to the invention is that of a component of a motor vehicle selected from fuel tanks, fuel pipes, bumpers and dashboards.

There are numerous advantages to the article in accordance with the invention. It exhibits in particular a high level of mechanical properties. When the article according to the invention is a film, the latter generally exhibits in particular a high tear strength.

The examples which follow are intended to illustrate the invention without, however, limiting the scope thereof.

### EXAMPLE 1

### Preparation of Blends Composed of a Propylene Homopolymer Grafted with Maleic Anhydride and of an Unmodified Propylene Homopolymer

1) Description of the Resins Eltex® P HL001P and Priex® 20015:

The resin Eltex® P HL001P is an unmodified propylene homopolymer sold by BP North America. The sample used exhibited an MFI_{2.16 kg, 230° C.} of 2.5 g/10 min, a melting point of 161° C. and a density of 900 kg/m³.

The resin Priex® 20015 is a propylene homopolymer chemically modified by Solvay. The propylene homopolymer resin on which Solvay carries out the chemical modification is the resin Eltex® P HL001P. The chemical modification which is carried out by Solvay on the abovementioned propylene homopolymer consists in grafting with maleic anhydride in a proportion of 0.05% by weight, followed by purifying from the free maleic anhydride. The sample of resin Priex® 20015 which is used exhibited an MFI_{2.16 kg, 230° C.} of 15 g/10 min.

2) Preparation of Blends of the Resins Priex® 20015 and Eltex® P HL001P:

Use was made of:
the resin Priex® 20015 described above;
the resin Eltex® P HL001P described above;
a Prism extruder, which is a co-rotating twin-screw extruder with a diameter of 15 mm and a length of 24 cm (I/D=16). The barrel is composed of two independent zones (Z1 and Z2), as well as of a convergence section and of a die comprising one hole. The speed of the screws was 200 rpm, the throughput was 2 kg/h and the temperature profile was as follows: Z1 (feeding of the resins): 230° C.; Z2: 230° C.; convergence section and die 230° C.

Two blends of resin Eltex® P HL001P and of resin Priex® 20015 were prepared, namely the “5% Priex® 20015” and “10% Priex® 20015” blends, which were respectively composed of 5% and 10% of resin Priex® 20015, made up to 100% with resin Eltex® P HL001P.

3) Mechanical Properties of the Blends Obtained in Comparison with the Starting Resins:

3-1) Elongation at Break (Tensile Test at 23° C.)

The elongation at break was determined according to a tensile test carried out according to Standards ISO 527-1 and 2; the modulus speed was 1 mm/min; the test speed was 50 mm/min; the distance between the tools was 115 mm; the standard gauge length was 50 mm; the type of test specimen was the ISO 1A type (115 mm); the load cell was of “10 kN tension” type; the extensometer was a Nohzwick Multisense and Traverse sensor; the temperature was 23° C.

The results presented in the following Table I were obtained:

TABLE I

| | Eltex ® P | Priex ® | 5% Priex ® | 10% Priex ® |
|---|---|---|---|---|
| | HL001P | 20015 | 20015 | 20015 |
| Elongation at | 11.5 | 10.7 | 11.8 | 11.9 |
| break (in %) | | | | |

Surprisingly, the results have shown a synergistic effect relating to the elongation at break between the resins Eltex® P HL001P and Priex® 20015 in the 5% and 10% Priex® 20015 blends: this is because the 5% and 10% Priex® 20015 blends exhibited a greater elongation at break than each of their components taken individually.

3-2) Softening Temperature in the Vicat 10N Test

The Vicat test was carried out according to Standard ISO 306 (1987) with a force of 10N. A temperature rise of 50±5° C./h was carried out; use was made of test specimens which were injection moulded, trimmed and cut out; the test specimens used had a thickness of 4±0.1 mm. The penetration was 1 mm.

The results presented in the following Table II were obtained:

TABLE II

| | Eltex ® P | Priex ® | 5% Priex ® | 10% Priex ® |
|---|---|---|---|---|
| | HL001P | 20015 | 20015 | 20015 |
| Vicat 10 N softening | 157 | 156 | 159 | 158 |
| temperature (in ° C.) | | | | |

Here again, and surprisingly, the results have shown a synergy relating to the softening temperature in the Vicat 10N test between the resins Eltex® P HL001P and Priex® 20015 in the 5% and 10% Priex® 20015 blends.

3-3) Change in the Tensile Elastic Modulus Over Time Under a Stress of 10 or 12.5 MPa (Creep Test)

This test was carried out on an ISO 1B test specimen (115 mm) according to Standard ISO 899-1 under a stress of 10 or 12.5 MPa at a temperature of 23° C.

The results obtained under a stress of 10 MPa are presented in the following Table III:

TABLE III

| Tensile elastic | Eltex ® P | Priex ® | 5% Priex ® | 10% Priex ® |
|---|---|---|---|---|
| modulus | HL001P | 20015 | 20015 | 20015 |
| After 10 h (in MPa) | 787 | 648 | 891 | 821 |
| After 100 h (in MPa) | 548 | 455 | 629 | 583 |

The results obtained under a stress of 12.5 MPa are presented in the following Table IV:

TABLE IV

| Tensile elastic | Eltex ® P | Priex ® | 5% Priex ® | 10% Priex ® |
|---|---|---|---|---|
| modulus | HL001P | 20015 | 20015 | 20015 |
| After 10 h (in MPa) | 676 | 525 | 726 | 682 |
| After 100 h (in MPa) | 473 | 377 | 521 | 487 |

The results obtained have shown a synergy relating to the change in the mechanical behaviour over time between the resins Eltex® P HL001P and Priex® 20015 in the 5% and 10% Priex® 20015 blends. This is because the 5% and 10% Priex® 20015 blends exhibited a greater tensile elastic modulus after 100 h and under a stress of 10 or 12.5 MPa than each of their components taken individually.

### EXAMPLE 2

### Preparation of Blends Composed of an Ionomeric Propylene Homopolymer and of an Unmodified Propylene Homopolymer

1) Synthesis of the Resin (Ion 1)

Use was made of:
the Priex® 20015 resin described in Example 1;
solutions of NaLac (sodium lactate: mixture of D- and L-isomer from Arcos: 256.4 ml of solution comprising 60% by weight per litre of aqueous solution) and of Na₂CO₃ at 200 g/l, in respective amounts of 5 and 2 mol. eq. (molar equivalents with respect to the number of carboxylic acid functional groups of the resin) for the NaLac;
a Clextral model BC 21 extruder, which is a co-rotating twin-screw extruder with a diameter of 25 mm and a length of 1000 mm (L/D=40). The barrel is composed of 10 independent zones (Z1 to Z10) and of a convergence section and of a die;
a screw speed of 200 rpm, a throughput of 10 kg/h and the following temperature profile: Z1 (feeding of the resin): 70° C.; Z2: 170° C.; Z3 (melting) and Z4 (NaLac injection): 200° C.; Z5 to Z8 (reaction, venting at atmospheric pressure, reaction, venting under vacuum at a set value of 2 mbar): 240° C.; Z9: 230° C.; Z10: 220° C.; convergence section and die: 220° C.
high pressure injectors for the injection respectively of the NaLac in Z4 and of the Na₂CO₃ in Z7.

The resin (Ion 1) thus obtained had an MFI (2.16 kg, 230° C.) of 1 g/10 min, an Na content of 0.88 g/kg and a melting point of 167° C.

2) Preparation of Blends of the Resins (Ion 1) and Eltex® HL001P

Use was made of:
the resin (Ion 1) described above;
the resin Eltex® P HL001P described in Example 1.

The protocol used to produce blends of these two resins was the same as that described in Example 1. The 5% (Ion 1) and 10% (Ion 1) blends obtained were respectively composed of 5% and of 10% of resin (Ion 1), made up to 100% with the resin Eltex® P HL001P.

3) Mechanical Properties of the Blends Obtained in Comparison with the Starting Resins

3-1) Elongation at Break (Tensile Test at 23° C.)

The elongation at break was determined according to the same protocol as that described in Example 1.

The results obtained are presented in the following Table V:

TABLE V

| | Eltex ® P | | 5% | 10% |
|---|---|---|---|---|
| | HL001P | (Ion 1) | (Ion 1) | (Ion 1) |
| Elongation at | 11.5 | 7 | 11.7 | 11.8 |
| break (in %) | | | | |

Surprisingly, the results have shown a synergy relating to the low-speed mechanical behaviour between the resins Eltex® HL001P and (Ion 1) in the 5% and 10% (Ion 1) blends. This is because the 5% and 10% (Ion 1) blends exhibited a greater elongation at break than each of their components taken individually.

3-2) Softening Temperature in the Vicat 10N and 50N Tests

The protocol used for this test was the same as that described in Example 1, with a measurement also with a force of 50N.

The results presented in the following Table VI were obtained:

TABLE VI

| | Eltex ® P | | 5% | 10% |
|---|---|---|---|---|
| | HL001P | (Ion 1) | (Ion 1) | (Ion 1) |
| Vicat 10 N softening | 157 | 156.5 | 159 | 158.5 |
| temperature (in ° C.) | | | | |
| Vicat 50 N softening | 101 | 105 | 107 | 105.5 |
| temperature (in ° C.) | | | | |

Here again, and surprisingly, the results have shown a synergy relating to the softening temperature in the Vicat 10N and 50N tests between the resins Eltex® P HL001P and (Ion 1) in the 5% and 10% (Ion 1) blends.

3-3) Impact Strength [Instrumented Falling Weight (IFW)] Test

The IFW test was carried out according to Standard ISO 7765-2. The temperature was 23° C.; the energy and the speed of the dart have values respectively of 247.5J and 4.43 m/s; the weight of the dart was 25.24 kg; the drop height was 1 m; the diameters of the dart and of the support were respectively 20 and 40 mm.

The results presented in the following Table VII were obtained:

TABLE VII

| | Eltex ® P | | 5% | 10% |
|---|---|---|---|---|
| | HL001P | (Ion 1) | (Ion 1) | (Ion 1) |
| Peak force (in N) | 445 | 436 | 688 | 531 |
| Impact strength | 0.47 | 0.25 | 0.87 | 0.6 |
| (in J/mm) | | | | |

Surprisingly, the results have shown a synergy relating to the high-speed mechanical behaviour between the resins Eltex® HL001P and (Ion 1) in the 5% and 10% (Ion 1) blends. The 5% and 10% (Ion 1) blends thus exhibited a greater peak force and a greater impact strength than each of their components taken individually.

### EXAMPLE 3

### Preparation of Blends Composed of a Random Propylene Copolymer Grafted with Maleic Anhydride and of an Unmodified Random Propylene Copolymer

1) Description of the Resins Eltex® P KS001 P and Priex® 25015

The resin Eltex® P KS001 P is an unmodified random propylene copolymer sold by BP North America Corporation. The sample used exhibited an MFI_{2.16 kg, 230° C.} of 4.3 g/10 min, a melting point of 134° C. and a density of 900 kg/m³.

The resin Priex® 25015 is a random propylene copolymer chemically modified by Solvay. The random propylene copolymer resin on which Solvay carries out the chemical modification is the resin Eltex® P KS001 P. The chemical modification which is carried out by Solvay consists in grafting with maleic anhydride in a proportion of 0.05% by weight, followed by purifying from the free maleic anhydride. The sample of resin Priex® 25015 which was used exhibited an MFI_{2.16 kg, 230° C.} of 15 g/10 min.

2) Preparation of the Blends of Resins Priex® 25015 and Eltex® P KS001P

The following were used:
the resin Priex® 25015 described above;
the resin Eltex® P KS001 P described above.

The protocol used for preparing the blends composed of these two resins was the same as that described in Example 1. The “5% Priex® 25015” and “10% Priex® 25015” blends thus obtained were respectively composed of 5% and of 10% of resin Priex® 25015, made up to 100% with resin Eltex® P KS001 P.

3) Mechanical Properties of the Blends Obtained in Comparison with the Starting Resins: Modulus and Yield Strength (Tensile Test at 23° C.)

The protocol used for this test was the same as that described in Example 1, except that here the modulus and the yield strength were measured.

The results presented in the following Table VIII were obtained:

TABLE VIII

| | Eltex ® P | Priex ® | 5% Priex ® | 10% Priex ® |
|---|---|---|---|---|
| | KS001P | 25015 | 25015 | 25015 |
| 0.05-0.25% Modulus | 753 | 637 | 815 | 774 |
| (in MPa) | | | | |
| Yield strength | 22.5 | 21.6 | 25.5 | 23.4 |
| (in MPa) | | | | |

Surprisingly, the results have shown a synergy relating to the low-speed mechanical behaviour between the resins Eltex® KS001P and Priex® 25015 in the 5% and 10% Priex® 20015 blends. This is because the 5% and 10% Priex® 20015 blends exhibited a greater tensile elastic modulus and a greater yield strength than each of their components taken individually.

### EXAMPLE 4

### Preparation of a Blend Composed of an Ionomeric Random Propylene Copolymer and of an Unmodified Random Propylene Copolymer

1) Synthesis of the Random Propylene Copolymer Resin (Ion 2)

Use was made of:
a sample of resin Priex® 25050; the resin Priex® 25050 is a random propylene copolymer chemically modified by Solvay; the random propylene copolymer on which Solvay carries out the chemical modification is the resin Eltex® P KS001 P described above; the chemical modification which is carried out by Solvay consists in grafting with maleic anhydride in a proportion of 0.1% by weight, followed by purifying from the free maleic anhydride. The sample of resin Priex®125050 which was used exhibited an MFI_{2.16 kg, 230° C.} of 50 g/10 min.
solutions of NaLac (sodium lactate: mixture of D- and L-isomer from Arcos: 256.4 ml of solution comprising 60% by weight per litre of aqueous solution) and of Na₂CO₃ at 200 g/l, in respective amounts of 5 and 2 mol. eq. (molar equivalents with respect to the number of carboxylic acid functional groups of the resin) for the NaLac;

The protocol used for the synthesis of the resin (Ion 2) was the same as that described in Example 2.

The resin (Ion 2) obtained had an MFI (2.16 kg, 230° C.) of 1.4 g/10 min, an Na content of 1.5 g/kg and a melting point of 137° C.

2) Preparation of a Blend Composed of the Resin (Ion 2) and of the Resin Eltex® P KS 001P

Use was made of:
the resin (Ion 2) described above,
the resin Eltex® P KS001P described above.

The protocol used for the preparation of the blend of these two resins was the same as that described in Example 1. The “10% (Ion 2)” blend obtained comprised 10% of resin (Ion 2), made up to 100% with the resin Eltex® P KS 001P.

3) Mechanical Properties of the Blend Obtained in Comparison with the Starting Resins: Impact Strength [Instrumented Falling Weight (IFW) Test]

The protocol used for this test was the same as that described in Example 2.

The results presented in the following Table IX were obtained:

TABLE IX

| | Eltex ® P | | 10% |
|---|---|---|---|
| | KS001P | (Ion 2) | (Ion 2) |
| Peak force (in N) | 2919 | 3085 | 3003 |
| Displacement at the peak force | 13.1 | 12.0 | 13.2 |
| (in mm) | | | |
| Energy at the peak force (in J) | 17.8 | 17.1 | 18.5 |
| Impact strength (in J/mm) | 17.0 | 10.7 | 17.9 |

The results showed a synergy relating to the high-speed mechanical behaviour between the resins Eltex® KS001P and (Ion 2) in the 10% (Ion 2) blend. This is because the 10% (Ion 2) blend exhibited a greater displacement at the peak force, a greater energy at the peak force and a greater impact strength than each of its components taken individually.

1-26. (canceled)

27. A method for improving the level of at least one mechanical property of a polyolefin composition (C2),
the mechanical property relating at least to the low-speed mechanical behavior, the operating temperature range, the high-speed mechanical behavior and/or the change in the mechanical behavior over time,
the polyolefin composition (C2) comprising at least one modified polyolefin (P2) chosen from polyethylenes and polypropylenes, the said polyolefin (P2) being modified by grafting with acid and/or anhydride groups, which groups are optionally completely or partially neutralized by a neutralizing agent,
up to a level which is improved both with respect to that of the mechanical property of the polyolefin composition (C2) and with respect to that of the mechanical property of a polyolefin composition (C1) obtained by replacing, weight for weight in the polyolefin composition (C2), all the modified polyolefin (P2) by at least one unmodified polyolefin (P1) chosen from polyethylenes and polypropylenes,
the method comprising using the unmodified polyolefin (P1) as an additive of the polyolefin composition (C2).

28. The method according to claim 27, wherein the mechanical property relates at least to the low-speed mechanical behavior, and the said mechanical property comprises the tensile elastic modulus and/or the elongation at break.

29. The method according to claim 27, wherein the mechanical property relates at least to the operating temperature range, and the said mechanical property comprises the softening temperature in the Vicat 10N test.

30. The method according to claim 27, wherein the mechanical property relates at least to the high-speed mechanical behavior, and the said mechanical property comprises the impact strength and/or the peak force in the instrumented falling weight test.

31. The method according to claim 27, wherein the mechanical property relates at least to the change in the mechanical behavior over time, and the mechanical property comprises the tensile elastic modulus after 100 h under a stress of 10 MPa.

32. The method according to claim 27, wherein the polyolefin (P1) is a polypropylene and the polyolefin (P2) is a polypropylene.

33. The method according to claim 32, wherein
the polyolefin (P1) is a propylene homopolymer,
the polyolefin (P2) is a propylene homopolymer, the acid and/or anhydride groups of which are not neutralized, and
the mechanical property relates either at least to the low-speed mechanical behavior or at least to the operating temperature range or at least to the change in the mechanical behavior over time.

34. The method according to claim 32, wherein
the polyolefin (P1) is a propylene homopolymer,
the polyolefin (P2) is a propylene homopolymer, the acid and/or anhydride groups of which are completely or partially neutralized, and
the mechanical property relates either at least to the low-speed mechanical behavior or at least to the operating temperature range or at least to the high-speed mechanical behavior.

35. The method according to claim 32, wherein
the polyolefin (P1) is a random propylene copolymer,
the polyolefin (P2) is a random propylene copolymer, the acid and/or anhydride groups of which are not neutralized, and
the mechanical property relates at least to the low-speed mechanical behavior.

36. The method according to claim 32, wherein
the polyolefin (P1) is a random propylene copolymer,
the polyolefin (P2) is a random propylene copolymer, the acid and/or anhydride groups of which are completely or partially neutralized, and
the mechanical property relates at least to the high-speed mechanical behavior.

37. The method according to claim 27, wherein the ratio by weight q_{w2} of the polyolefin (P2) to the polyolefin composition (C2) [(P2): (C2)] is, before the addition of the polyolefin (P1), greater than 0.99.

38. The method according to claim 27, wherein the ratio by weight r_{w} of the polyolefin (P1) to the polyolefin (P2) [(P 1):(P2)] is greater than 8 and less than 35.

39. A method for improving the level of at least one mechanical property of a polyolefin composition (C1),
the mechanical property relating at least to the low-speed mechanical behavior, the operating temperature range, the high-speed mechanical behavior and/or the change in the mechanical behavior over time,
the polyolefin composition (C1) comprising at least one unmodified polyolefin (P1) chosen from polyethylenes and polypropylenes,
up to a level which is improved both with respect to that of the mechanical property of the polyolefin composition (C1) and with respect to that of the mechanical property of a polyolefin composition (C2) obtained by replacing, weight for weight in the polyolefin composition (C1), all the unmodified polyolefin (P1) by at least one at least one modified polyolefin (P2) chosen from polyethylenes and polypropylenes, the said polyolefin (P2) being modified by grafting with acid and/or anhydride groups, which groups are optionally completely or partially neutralized by at least one neutralizing agent,
the method comprising using the modified polyolefin (P2) as additive of the polyolefin composition (C1).

40. The method according to claim 39, wherein
the polyolefin (P1) is a propylene homopolymer,
the polyolefin (P2) is a propylene homopolymer, the acid and/or anhydride groups of which are not neutralized, and
the mechanical property relates either at least to the low-speed mechanical behavior or at least to the operating temperature range or at least to the change in the mechanical behavior over time.

41. The method according to claim 39, wherein:
the polyolefin (P1) is a propylene homopolymer,
the polyolefin (P2) is a propylene homopolymer, the acid and/or anhydride groups of which are completely or partially neutralized, and
the mechanical property relates either at least to the low-speed mechanical behavior or at least to the operating temperature range or at least to the high-speed mechanical behavior.

42. The method according to claim 39, wherein:
the polyolefin (P1) is a random propylene copolymer,
the polyolefin (P2) is a random propylene copolymer, the acid and/or anhydride groups of which are not neutralized, and
the mechanical property relates at least to the low-speed mechanical behavior.

43. The method according to claim 39, wherein:
the polyolefin (P1) is a random propylene copolymer,
the polyolefin (P2) is a random propylene copolymer, the acid and/or anhydride groups of which are completely or partially neutralized, and
the mechanical property relates at least to the high-speed mechanical behavior.

44. The method according to claim 39, wherein the ratio by weight q_{w1} of the polyolefin (P1) to the polyolefin composition (C1) [(P1):(C1)] is, before the addition of the polyolefin (P2), greater than 0.995.

45. The method according to claim 39, wherein the ratio by weight r_{w} of the polyolefin (P1) to the polyolefin (P2) [(P1):(P2)] is greater than 8 and less than 35.

46. A process for the preparation of a polyolefin composition which is improved with respect to a preexisting polyolefin composition (C1) comprising at least one unmodified polyolefin (P1) chosen from polyethylenes and polypropylenes,
the process being carried out in the need of improving the level of at least one mechanical property of the preexisting polyolefin composition (C1),
the mechanical property relating at least to the low-speed mechanical behavior, the operating temperature range, the high-speed mechanical behavior and/or the change in the mechanical behavior over time,
the level of the mechanical property being improved up to a level which is improved both with respect to that of the mechanical property of the preexisting polyolefin composition (C1) and with respect to that of the mechanical property of a polyolefin composition (C2) obtained by replacing, weight for weight in the preexisting polyolefin composition (C1), all of the unmodified polyolefin (P1) by at least one modified polyolefin (P2) chosen from polyethylenes and polypropylenes, the said polyolefin (P2) being modified by grafting with acid and/or anhydride groups which are optionally completely or partially neutralized by at least one neutralizing agent,
